(19) United States
(12) Patent Application Publication
(10) Pub. No.: US 2009/0320335 A1
(43) Pub. Date: Dec. 31, 2009

(54) "Kaddie card" stand

(76) Inventors: Freda Lorraine Thomas, Egg Harbor City, NJ (US); Michael P. Wan, (US)

Correspondence Address: Freda L. Thomas, 692 Jupiter Hills Lane, Egg Harbor City, NJ, 08215, US

(21) Appl. No.: 12/214,977

(22) Filed: Jun. 25, 2008

(51) Int. Cl. G09F 15/00

(52) U.S. Cl. 40/1

(57) ABSTRACT

The “KADDIE CARD” stand is a uniquely designed and versatile brace wherein the leg will flip and extend out to stabilize item to be attached. An adhesive is applied to the front of the stand and covered with a peel-off film. The peel-off film is removed when ready for attachment. The “KADDIE CARD” stand can be attached to business cards; postcards; photographs; calendars; flyers; brochures and other documents. No more searching for a brace to lean on or an expensive frame, The “KADDIE CARD” stand allows the aforementioned items to be displayed in an upright position quickly and with ease.

### FIGURE DESCRIPTIONS

FIG. 1. Front perspective view of the “KADDIE CARD” stand

FIG. 2. Back perspective view of the “KADDIE CARD” stand

FIG. 3. Side perspective view of the “KADDIE CARD” stand

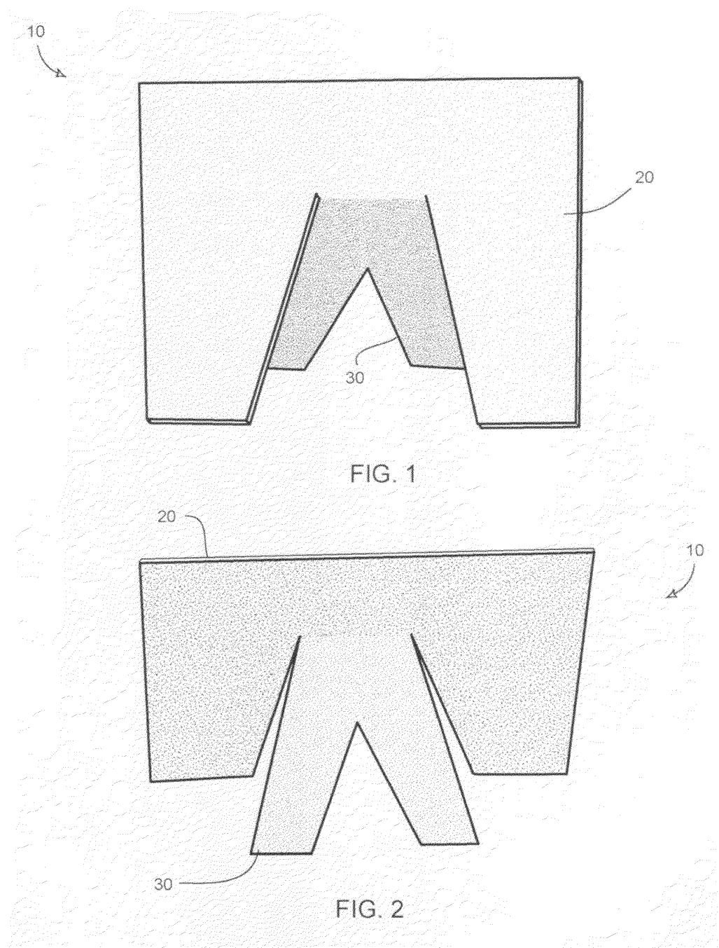

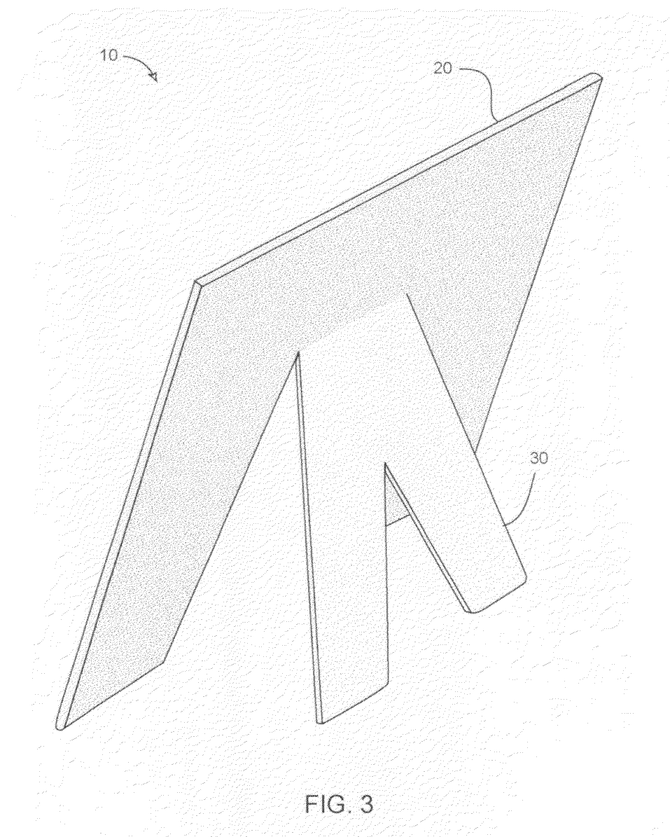

### NUMBER DESCRIPTION LIST

10. The “Kaddie Card” stand of the invention

20. Front surface with the peel-off film cover adhesive upon which items are attached

30. Unique flip-out leg brace

What is claimed is:

1. Stand with built-in leg brace that flips-out and an adhesive front to stabilize item upright

2. The invention of claim 1 wherein the stand itself may be attached by a peel-off film covered tape

3. The invention of claim 1 wherein the adhesive or paste may be user applied to front of stand

4. The invention of claim 1 wherein the stand itself may be by a staple/clip
